(19) United States
(12) Patent Application Publication
(10) Pub. No.: US 2026/0244465 A1
(43) Pub. Date: Aug. 20, 2026

(54) DYNAMICALLY BUILDING TROUBLESHOOTING GUIDES CONTEXTUAL TO SITUATIONS

(71) Applicant: INTERNATIONAL BUSINESS MACHINES CORPORATION, Armonk, NY (US)

(72) Inventors: Hemant Kumar Sivaswamy, Bangalore (IN); Viswas Purohit, East Amherst, NY (US); Charan Acharya Chandrashekar, Bangalore (IN); Nitee Shah, Thane (IN); Mohsen Nasseri, East Meadow, NY (US)

(21) Appl. No.: 19/054,125

(22) Filed: Feb. 14, 2025

(51) Int. Cl. G06F 9/451; G06T 15/00; G07C 5/08

(52) U.S. Cl. CPC G06F 9/453; G06T 15/005; G07C 5/0808

(57) ABSTRACT

Systems, methods, and computer program products for generating contextual instructional guides are disclosed. A method may comprise detecting from one or more sensors an error condition of a first vehicle; reading a first capability profile for a first user of the first vehicle; identifying a set of necessary tools for completion of the manual correction; identifying a set of available tools to the first user; determining whether the set of necessary tools is a subset of the set of available tools; providing the first capability profile as input to a machine learning model; reading an indication of whether the first user needs assistance; providing a characterization of the error condition, a characterization of the set of available tools, and the first capability profile as input to a generative machine learning model; reading an instructional guide; and presenting the instructional guide to the first user via a first computing platform.

### BACKGROUND

Embodiments of the present disclosure relate to generating instructional guides, and more specifically, to generating instructional guides in accordance with situational context.

### BRIEF SUMMARY

According to embodiments of the present disclosure, systems, methods of, and computer program products for generating contextual instructional guides are disclosed. In various embodiments, an error condition of a first vehicle is detected from one or more sensors. The error condition may require a manual correction. A first capability profile for a first user of the first vehicle is read. A set of necessary tools for completion of the manual correction is identified. A set of available tools is identified. The set of available tools may be available to the first user. Whether the set of necessary tools is a subset of the set of available tools is determined. The first capability profile is provided as input to a machine learning model. The machine learning model may be configured to determine whether the first user needs assistance to operate the set of necessary tools. An indication of whether the first user needs assistance is read from the machine learning model.

A characterization of the error condition, a characterization of the set of available tools, and the first capability profile are provided as input to a generative machine learning model. An instructional guide is read from the generative machine learning model. The instructional guide may have been generated by the generative machine learning model based on the input thereto. The instructional guide may characterize one or more steps for manually correcting the error condition. The instructional guide is presented to the first user via a first computing platform.

### BRIEF DESCRIPTION OF THE DRAWINGS

FIG. 1 is a flow diagram depicting an exemplary method of generating contextual instructional guides, in accordance with one or more embodiments of this disclosure.

FIG. 2 is a flow diagram depicting an exemplary method of generating contextual instructional guides, in accordance with one or more embodiments of this disclosure.

FIG. 3 depicts a computing node according to one or more embodiments of the present disclosure.

### DETAILED DESCRIPTION

Some mechanical issues may be corrected according to one or more manual solutions. Each solution may require a person using a different set of tools and/or a different method. Accordingly, applicable methods for the person depend on the physical capabilities of the person and/or tools available to the person. However, in real-life emergency situations, a person may not know any methods for manually correcting issues, let alone a method that works for their capabilities and the tools available to them. Further, preexisting instructional guides for correcting a mechanical issue may only include methods not suitable for the person and/or may be difficult to understand. Systems, methods, and computer program products described herein generate customized instructional guides based on the person's capabilities, knowledge to operate tools, the set of available tools, and/or other information. Particularly, the generation of such customized instructional guides may comprise transmitting requests to other people and/or services having skills and/or tools the person may need for performing a manual solution.

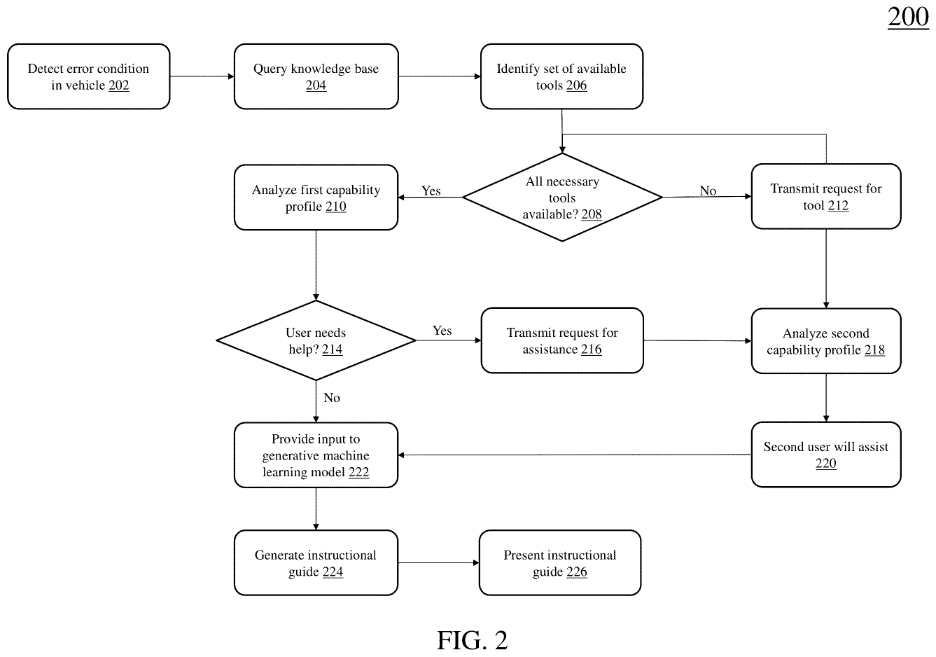

Referring now to FIG. 2, a flowchart illustrating an exemplary method 200 of generating contextual instructional guides is depicted. The operations of method 200 presented below are intended to be illustrative. In some implementations, method 200 is accomplished with one or more additional operations not described and/or without one or more of the operations discussed. The operations of method 200 may be performed in another order. Additionally, the order in which the operations of method 200 are illustrated in FIG. 2 and described below is not intended to be limiting.

In some implementations, method 200 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 200.

Operation 202 may comprise detecting an error condition in a first vehicle. For example, the first vehicle is a car, a boat, a plane, a bus, a van, and/or another vehicle. The error condition may indicate, characterize, and/or comprise a problem with the first vehicle. For example, the problem comprises a burst pipe, a flat tie, low oil, low or empty coolant, low or empty windshield wiper fluid, a windshield wiper requiring replacement, a dead battery, and/or another problem with the first vehicle. Detecting the problem may comprise detecting an error condition of the first vehicle. The error condition may identify and/or characterize the problem. The error condition may require a manual correction. The manual correction may require a human to correct the error condition. The manual correction may require the human to use one or more tools while correcting the error condition. The manual correction may comprise a plumbing correction, an electrical correction, a carpentry correction, and/or another type of manual correction.

Operation 204 may comprise querying a knowledge base. The knowledge base may be queried based on the error condition. The knowledge base may comprise a set of necessary tools for manually correcting each of a plurality of error conditions. The knowledge base may comprise a set of instructions for manually correcting each of the plurality of error conditions. In some implementations, the set of instructions for an error condition is context independent. The plurality of error conditions may comprise at least one known error condition for the first vehicle. Each set of necessary tools may comprise one or more tools necessary for completing a manual correction of an error condition.

For example, the set of necessary tools associated with a flat tire error condition comprises a spare tire, a lug wrench, a jack, and/or another tool. For example, the set of necessary tools associated with a dead battery error condition comprises jumper cables, another vehicle comprising a working battery, and/or another tool. For example, the set of necessary tools associated with a low oil error condition comprises an oil filter, an oil pan, a wrench/socket set, an oil filter wrench, a funnel, and/or another tool. In some implementations, the set of necessary tools for an error condition comprises an indication of whether a certain tool is always necessary for the manual correction or sometimes necessary. For example, the set of necessary tools for a wiper blades replacement error condition may comprise an indication that a screwdriver is sometimes necessary.

For example, the knowledge base comprises a set of necessary tools for manually correcting the detected error condition. Querying the knowledge base may comprise retrieving the set of necessary tools associated with the error condition. For example, the knowledge base is in the form of a database, a flat file, and/or another form suitable for dynamic and real-time access.

Operation 206 may comprise identifying a set of available tools. The set of available tools may be available to a first user. The first user may be a passenger and/or a driver of the first vehicle. In some implementations, each available tool comprises an internet of things (IoT) sensor. Identifying the set of available tools may comprise receiving one or more signals. The one or more signals may identify the set of available tools. For example, each signal is received from an IoT sensor for an available tool. Each signal may identify the available tool from which it was received.

In some implementations, one or more cameras is disposed inside the first vehicle. A camera may be disposed such that the camera is configured to capture a storage area and/or another area of the first vehicle. For example, multiple cameras may be arranged in and/or around the first vehicle to capture more than one field of view. Identifying the set of available tools may comprise reading at least a first frame captured by the one or more cameras. The one or more cameras may depict at least the set of available tools. The set of available tools may be identified based at least on the first frame. For example, the set of available tools is identified using computer vision.

Operation 208 may comprise determining whether all necessary tools are available to the first user. Said determination may comprise determining whether the set of necessary tools is a subset of the set of available tools. Operation 212 may comprise transmitting a request for at least one necessary tool. The at least one necessary tool may be a necessary tool that is not comprised by the set of available tools. The request may be transmitted to a second vehicle and/or a computing platform associated with a second user. The second user may be a passenger and/or a driver of the second vehicle.

Operation 212 may comprise determining the tools needed by the first user for the manual correction are available to the second user. For example, operation 212 comprises determining each necessary tool is available to the first user and/or the second user. Operation 212 may comprise receiving and/or reading an indication that the second user will lend one or more necessary tools to the first user. The indication may be received from the second vehicle, a computing platform associated with the second user, and/or another device. The one or more necessary tools may be added to the set of available tools responsive to reading the indication. For example, requests may be transmitted to different vehicles and/or users until all necessary tools are available to the first user. For example, the set of tools available to the second user and the set of available tools does not comprise each tool of the set of necessary tools. In such an example, operation 212 may comprise transmitting a request for assistance and/or for tools to a roadside assistance service and/or another entity.

In some implementations, method 200 comprises generating one or more capability profiles. Each capability profile may be associated with a user. The capability profile for a user may comprise a degree of mobility of the user, a degree of strength of the user, a skill level of the user, activity history of the user, a characterization of one or more capabilities of the user, preferences of the user, the user's height, the user's weight, a characterization of one or more health conditions of the user, the first user's age, a characterization of the user's eyesight, and/or other information. For example, the capability profile comprises at least one physical characteristic of the user. For example, the characterization of the user's eyesight may comprise an indication of the user's visual acuity. The activity history of the user may characterize the first user's prior experience. For example, the activity history of the user may characterize one or more other manual corrections successfully and/or unsuccessfully performed by the first user. For example, preferences of the user may indicate the handedness of the first user, a side preference for activity of the first user, and/or other activity preferences.

For example, method 200 comprises generating a first capability profile for the first user. Generating the first capability profile may comprise prompting the first user to provide information. For example, prompting the first user comprises presenting a user interface comprising one or more fields for entering the information via a computing platform associated with the first user. Generating the first capability profile may comprise reading information measured by a wearable device. For example, generating the first capability profile comprises reading a heart rate, a temperature, a blood oxygen measurement, and/or other information measured by one or more sensors of a wearable device. The wearable device may be a blood pressure cuff, a smart ring, a smart watch, and/or another device comprising sensors. In some implementations, generating the first capability profile comprises reading an image. The image may depict at least the first user. For example, generating the first capability profile comprises determining the first user wears glasses based on the image. For example, the generating the first capability profile comprises determining the first user has one arm based on the image. In some implementations, generating the first capability profile comprises reading values measured by one or more sensors disposed in or around the first user and/or the first vehicle.

Operation 210 may comprise analyzing the first capability profile. Operation 210 may comprise reading the first capability profile. The first capability profile may be analyzed responsive to determining all necessary tools are available to the first user. Analyzing the first capability profile may comprise reading the first capability profile for the first user. Analyzing the first capability profile may comprise providing one or more of the first capability profile, the second capability profile, and/or one or more other capability profiles as input to a machine learning model. In some implementations, the machine learning model is configured to determine whether the first user needs assistance to operate the set of necessary tools. The machine learning model may be and/or use a random forest, Support Vector Machines (SVM), gradient boosting, and/or other machine learning methods. In some implementations, the machine learning model is configured to determine a probability that one or more of the first user, the second user, and/or one or more other users are capable of manually correcting the error condition.

Operation 214 may comprise determining whether the first user needs assistance to complete the manual correction. For example, determining whether the first user needs assistance comprises determining whether the first user can operate the set of necessary tools independently. Determining whether the first user needs assistance may comprise determining whether the first user and the second user can operate the set of necessary tools independently and/or together. Said determination may comprise reading output generated by the machine learning model based on the input thereto. The output may indicate whether the first user needs assistance. Said determination may be made based on the output generated by the machine learning model.

Operation 216 may comprise transmitting a request for assistance. Operation 216 may be performed responsive to determining the first user needs assistance to complete the manual correction. The request may be transmitted to the second vehicle, a computing platform associated with the second user, a roadside assistance service, and/or another device.

Operation 218 may comprise analyzing the second capability profile. In some implementations, the second capability profile is analyzed responsive to transmitting the request for the at least one necessary tool and/or transmitting the request for the at least one necessary tool. In some implementations, the second capability profile is analyzed responsive to reading a response indicating an intent to lend the at least one necessary tool and/or reading a response indicating an intent to assist the first user. Analyzing the second capability profile may comprise providing the first capability profile, the second capability profile, and/or other information as input to the machine learning model. Analyzing the second capability profile may comprise reading a second output generated by the machine learning model based on at least the second capability profile. The second output may indicate whether the first user and/or the second user need assistance to manually correct the error condition. For example, the second output is in the form of a probability. The second output may indicate the first user and/or the second user are capable of manually correcting the error condition by virtue of the probability being at least a minimum probability. For example, the second output indicates the first user and/or the second user are capable of manually correcting the error condition.

Operation 220 may comprise determining the second user will assist the first user. Determining the second user will assist the first user may comprise reading a response to the request for assistance. For example, the response may be received from the second vehicle and/or a computing platform associated with the second user.

Operation 222 may comprise providing input to a generative machine learning model. The generative machine learning model may be configured to generate an instructional guide based on the input thereto. The instructional guide may be particularly suited for manually correcting the error condition in accordance with user capabilities and the context surrounding the first vehicle. For example, if the first vehicle is on sand and the error condition is a flat tire, the instructional guide may not use a jack. The instructional guide may characterize one or more steps for manually correcting the error condition. In some implementations, the instructional guide is in the form of natural language, an image, a video, and/or another form.

For example, the generative machine learning model may be a generative adversarial network (GAN), an autoregressive model, a diffusion model, a variational autoencoder (VAE), a flow-based model, and/or another type of machine learning model. The input to the generative machine learning model may comprise one or more of the first capability profile, the second capability profile, the error condition, the knowledge base, vehicle information, contextual information, and/or other information. For example, the vehicle information characterizes the age of, the engine(s) in, the type of, the make of, the model of, the history of and/or other information about the first vehicle. For example, the history of the first vehicle may comprise accidents and/or other incidents associated with the first vehicle. The contextual information may characterize a location of the first vehicle, a time of day, a surface on which the first vehicle is positioned, weather conditions, and/or other information.

Operation 224 may comprise generating the instructional guide. The instructional guide may have been generated by the generative machine learning model. Generating the instructional guide may comprise reading the instructional guide generated by the generative machine learning model based on the input thereto.

Operation 226 may comprise presenting the instructional guide to the first user. The instructional guide may be presented via the first vehicle and/or a computing platform associated with the first user. For example, the first vehicle may comprise a computing platform associated with the first user. For example, the instructional guide is presented via a heads-up display, smart glasses, augmented reality glasses, a smart device, and/or another device. In some implementations, the instructional guide is presented to the first user as text, an image, a video, and/or in another form.

For example, the instructional guide is presented using augmented reality. Presenting the instructional guide may comprise providing the instructional guide as input to a three-dimensional model generator. Presenting the instructional guide may comprise reading a series of three-dimensional models representing the instructional guide. For example, each three-dimensional model may depict at least a portion of the instructional guide. In some implementations, presenting the instructional guide comprises presenting the series of three-dimensional models via the first computing platform. For example, the first computing platform is a heads-up display. In such an example, presenting a three-dimensional model comprises projecting the three-dimensional model onto a windshield or another window.

Presenting the instructional guide may comprise reading a series of frames. Each frame may be associated with a three-dimensional model of the series of models. The series of frames may be captured by a camera that is part of and/or disposed near the platform for displaying the instructional guide. Presenting the instructional guide may comprise superimposing the three-dimensional model on its associated frame to generate a series of augmented frames. Presenting the instructional guide may comprise presenting the series of augmented frames.

Presenting the instructional guide may comprise determining the first user has completed a step of the instructional guide. In some implementations, said determination comprises reading user input indicating the first user has completed the step. Presenting the instructional guide may comprise updating the presentation to reflect the next step of the instructional guide.

In some implementations, method 200 comprises detecting the first user is no longer performing steps of the instructional guide. Method 200 may comprise determining an end status of the first user's activity. The end status may indicate if the first user has completed manual correction or if the first user was unable to complete the manual correction. In some implementations, method 200 comprises updating the first capability profile in accordance with the end status. In some implementations, method 200 comprises updating the knowledge base in accordance with the instructional guide.

In some implementations, method 200 comprises reading a characterization of feedback for the instructional guide. The characterization may be user input provided to a computing platform. For example, method 200 comprises reading user input provided by the first user to a computing platform. Method 200 may comprise training the generative machine learning model based on the characterization of the feedback. For example, training the generative machine learning model comprises providing information characterizing the feedback as input to the generative machine learning model.

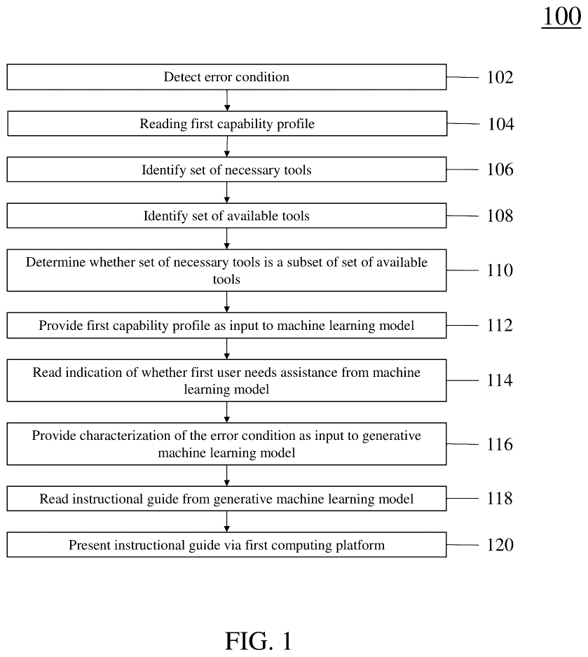

Referring now to FIG. 1, a flowchart illustrating an exemplary method 100 of generating contextual instructional guides is depicted. The operations of method 100 presented below are intended to be illustrative. In some implementations, method 100 is accomplished with one or more additional operations not described and/or without one or more of the operations discussed. The operations of method 100 may be performed in another order. Additionally, the order in which the operations of method 100 are illustrated in FIG. 1 and described below is not intended to be limiting.

In some implementations, method 100 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 may comprise detecting from one or more sensors an error condition of a first vehicle. The error condition may require a manual correction. Operation 104 may comprise reading a first capability profile for a first user of the first vehicle. Operation 106 may comprise identifying a set of necessary tools for completion of the manual correction. Operation 108 may comprise identifying a set of available tools. The set of available tools may be available to the first user. Operation 110 may comprise determining whether the set of necessary tools is a subset of the set of available tools. Operation 112 may comprise providing the first capability profile as input to a machine learning model. The machine learning model may be configured to determine whether the first user needs assistance to operate the set of necessary tools. Operation 114 may comprise reading an indication of whether the first user needs assistance. The indication may be read from the machine learning model.

Operation 116 may comprise providing a characterization of the error condition, a characterization of the set of available tools, and the first capability profile as input to a generative machine learning model. Operation 118 may comprise reading an instructional guide from the generative machine learning model. The instructional guide may have been generated by the generative machine learning model based on the input thereto. The instructional guide may characterize one or more steps for manually correcting the error condition. Operation 120 may comprise presenting the instructional guide to the first user via a first computing platform.

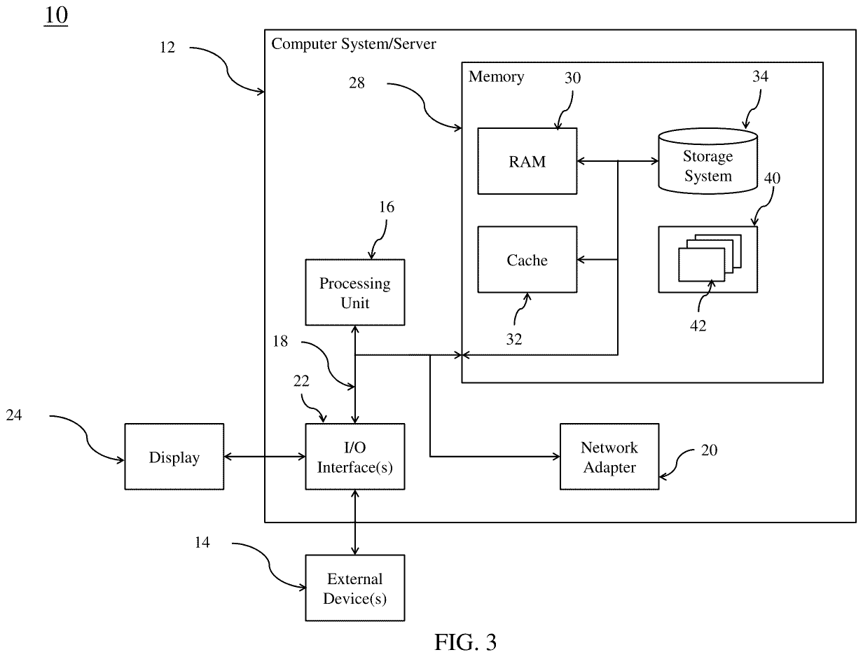

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the first user's computer, partly on the first user's computer, as a stand-alone software package, partly on the first user's computer and partly on a remote computer or entirely on the remote computer or server. In the latter scenario, the remote computer may be connected to the first user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of generating contextual instructional guides, the method comprising:
detecting from one or more sensors an error condition of a first vehicle, the error condition requiring a manual correction;
reading a first capability profile for a first user of the first vehicle;
identifying a set of necessary tools for completion of the manual correction;
identifying a set of available tools, the set of available tools being available to the first user;
determining whether the set of necessary tools is a subset of the set of available tools;
providing the first capability profile as input to a machine learning model configured to determine whether the first user needs assistance to operate the set of necessary tools;
reading from the machine learning model an indication of whether the first user needs assistance;
providing a characterization of the error condition, a characterization of the set of available tools, and the first capability profile as input to a generative machine learning model;
reading from the generative machine learning model an instructional guide generated thereby based on the input thereto, the instructional guide characterizing one or more steps for manually correcting the error condition; and
presenting the instructional guide to the first user via a first computing platform.

2. The method of claim 1, wherein each of the available tools comprises an internet of things (IoT) sensor, wherein said identifying of the set of available tools comprises:
receiving, from the IoT sensor for each of the available tools, a signal identifying that available tool.

3. The method of claim 1, wherein a camera is disposed inside the first vehicle, wherein said identifying of the set of available tools comprise:
reading at least a first frame captured by the camera depicting at least the set of available tools; and
identifying the set of available tools based on the at least first frame.

4. The method of claim 1, wherein the set of necessary tools is not a subset of the set of available tools, the method further comprising:
transmitting a signal to a second vehicle, the signal indicating a request for at least one of the set of necessary tools.

5. The method of claim 4, the method further comprising:
reading a second capability profile for a second user of the second vehicle;
determining the first user and the second user can operate the set of necessary tools based on the first capability profile and the second capability profile; and
providing the second capability profile with the first capability profile as input to the generative machine learning model.

6. The method of claim 1, wherein the indication indicates that the first user needs assistance to operate the set of necessary tools, the method further comprising:
transmitting a signal to a second vehicle, the signal indicating a request for a second user to assist in completion of the one or more steps.

7. The method of claim 1, the method further comprising:
reading a characterization of feedback for the instructional guide provided by the first user via the first computing platform; and
training the generative machine learning model based on the characterization of the feedback.

8. The method of claim 1, wherein the first computing platform comprises a camera configured to capture a series of frames depicting the first user's view, wherein said presenting of the instructional guide comprises:
providing the instructional guide as input to a three-dimensional model generator;
reading a series of three-dimensional models representing the instructional guide;
reading a series of frames, wherein each frame is associated with a three-dimensional model of the series of models;
superimposing the three-dimensional model on its associated frame to generate a series of augmented frames; and
presenting the series of augmented frames to the first user via the first computing platform.

9. The method of claim 1, the method further comprising:
updating the first capability profile based on the instructional guide responsive to the first user completing the one or more steps.

10. The method of claim 1, wherein the first capability profile comprises one or more of the first user's age, a characterization of the first user's physical strength, a characterization of the first user's skills, a characterization of the first user's prior experience, and a characterization of a physical characteristic of the first user.

11. A computer program product comprising:
one or more computer-readable storage media; and
program instructions stored on the one or more computer-readable storage media to perform operations comprising:
detecting from one or more sensors an error condition of a first vehicle, the error condition requiring a manual correction;
reading a first capability profile for a first user of the first vehicle;
identifying a set of necessary tools for completion of the manual correction;
identifying a set of available tools the set of available tools being available to the first user;
determining whether the set of necessary tools is a subset of the set of available tools;
providing the first capability profile as input to a machine learning model configured to determine whether the first user needs assistance to operate the set of necessary tools;
reading from the machine learning model an indication of whether the first user needs assistance;
providing a characterization of the error condition, a characterization of the set of available tools, and the first capability profile as input to a generative machine learning model;
reading from the generative machine learning model an instructional guide generated thereby based on the input thereto, the instructional guide characterizing one or more steps for manually correcting the error condition; and
presenting the instructional guide to the first user via a first computing platform.

12. The computer program product of claim 11, wherein each of the available tools comprises an internet of things (IoT) sensor, wherein said identifying of the set of available tools comprises:
receiving, from the IoT sensor each of the available tools, a signal identifying that available tool.

13. The computer program product of claim 11, wherein the set of necessary tools is not a subset of the set of available tools, the operations further comprising:
transmitting a signal to a second vehicle, the signal indicating a request for at least one of the set of necessary tools.

14. The computer program product of claim 13, the operations further comprising:
reading a second capability profile for a second user of the second vehicle;
determining the first user and the second user can operate the set of necessary tools based on the first capability profile and the second capability profile; and
providing the second capability profile with the first capability profile as input to the generative machine learning model.

15. The computer program product of claim 11, wherein the first computing platform comprises a camera configured to capture a series of frames depicting the first user's view, wherein said presenting of the instructional guide comprises:
providing the instructional guide as input to a three-dimensional model generator;
reading a series of three-dimensional models representing the instructional guide;
reading the series of frames, wherein each frame is associated with a three-dimensional model of the series of models;
superimposing the three-dimensional model on its associated frame to generate a series of augmented frames; and
presenting the series of augmented frames to the first user via the first computing platform.

16. A computer system comprising:
a processor set;
one or more computer-readable storage media; and
program instructions stored on the one or more computer-readable storage media to perform operations comprising:
detecting from one or more sensors an error condition of a first vehicle, the error condition requiring a manual correction;
reading a first capability profile for a first user of the first vehicle;
identifying a set of necessary tools for completion of the manual correction;
identifying a set of available tools the set of available tools being available to the first user;
determining whether the set of necessary tools is a subset of the set of available tools;
providing the first capability profile as input to a machine learning model configured to determine whether the first user needs assistance to operate the set of necessary tools;
reading from the machine learning model an indication of whether the first user needs assistance;
providing a characterization of the error condition, a characterization of the set of available tools, and the first capability profile as input to a generative machine learning model;
reading from the generative machine learning model an instructional guide generated thereby based on the input thereto, the instructional guide characterizing one or more steps for manually correcting the error condition; and
presenting the instructional guide to the first user via a first computing platform.

17. The computer system of claim 16, wherein each of the available tools comprises an internet of things (IoT) sensor, wherein said identifying of the set of available tools comprises:
receiving, from the IoT sensor each of the available tools, a signal identifying that available tool.

18. The computer system of claim 16, wherein the set of necessary tools is not a subset of the set of available tools, the operations further comprising:
transmitting a signal to a second vehicle, the signal indicating a request for at least one of the set of necessary tools.

19. The computer system of claim 18, the operations further comprising:
reading a second capability profile for a second user of the second vehicle;
determining the first user and the second user can operate the set of necessary tools based on the first capability profile and the second capability profile; and
providing the second capability profile with the first capability profile as input to the generative machine learning model.

20. The computer system of claim 16, wherein the first computing platform comprises a camera configured to capture a series of frames depicting the first user's view, wherein said presenting of the instructional guide comprises:
providing the instructional guide as input to a three-dimensional model generator;
reading a series of three-dimensional models representing the instructional guide;
reading the series of frames, wherein each frame is associated with a three-dimensional model of the series of models;
superimposing the three-dimensional model on its associated frame to generate a series of augmented frames; and
presenting the series of augmented frames to the first user via the first client computing platform.
